(19) United States
(12) Patent Application Publication
(10) Pub. No.: US 2026/0160018 A1
(43) Pub. Date: Jun. 11, 2026

(54) PRINTING METHOD AND FABRIC FOR PRINTING

(71) Applicant: SEIKO EPSON CORPORATION, Tokyo (JP)

(72) Inventors: Emiri KOIKE, SHIOJIRI-SHI (JP); Yoshitaka MIYAJIMA, MATSUMOTO-SHI (JP); Sho SHIMIZU, MATSUMOTO-SHI (JP)

(21) Appl. No.: 19/412,022

(22) Filed: Dec. 8, 2025

(30) Foreign Application Priority Data
Dec. 10, 2024 (JP) 2024-215150

(51) Int. Cl. D06P 3/82; B41J 3/407; D06M 17/00; D06P 5/30

(52) U.S. Cl. CPC D06P 3/82; B41J 3/4078; D06M 17/00; D06P 5/30; D10B 2401/022

(57) ABSTRACT

A printing method includes: a defibrating step S2 of defibrating a raw material C in a dry condition to produce fibers; a mixing step S3 of mixing an additive with the fibers obtained in the defibrating step S2 to produce a mixture; a depositing step S4 of depositing the mixture in air on a fabric N1 serving as a first layer L1 having air permeability to produce a web W serving as a second layer L2 having water absorbency; an attaching step S5 of attaching a fabric N3 serving as a third layer L3 to a surface of the web W; a forming step S6 of laminating the fabric N1, the web W, and the fabric N3, and then heating and pressurizing to form a fabric for printing CL1 including the first layer L1, the second layer L2, and the third layer L3; and printing step S7 of performing inkjet printing on the third layer L3 of the fabric for printing CL1.

The present application is based on, and claims priority from JP Application Serial Number 2024-215150, filed Dec. 10, 2024, the disclosure of which is hereby incorporated by reference herein in its entirety.

### BACKGROUND

### 1. Technical Field

The present disclosure relates to a printing method and a fabric for printing.

### 2. Related Art

In the related art, a printing method using an inkjet system has been known. For example, JP-A-2023-135981 discloses a liquid ejection method in which a textile fabric is attached to a conveyance belt, transported, and ink is applied from an inkjet head.

JP-A-2023-135981 is an example of the related art.

However, the method described in JP-A-2023-135981 has a problem in that it is difficult to improve color developability by printing in a thin fabric. Specifically, when a fabric such as textile fabric is printed by an inkjet method, increasing the amount of ink that adheres is likely to improve color developability. However, the amount of ink that can be absorbed by the fabric has an upper limit, and when the amount exceeds the upper limit, bleeding may occur in an image or the like to be formed. For this reason, in a thin fabric, it is necessary to limit the amount of ink that adheres in order to suppress the occurrence of bleeding, making it difficult to improve color developability. That is, there has been a demand for a printing method for improving color developability on a thin fabric.

### SUMMARY

A printing method includes: defibrating a fabric in a dry condition to produce fibers; mixing an additive with the fibers obtained in the defibrating to produce a mixture; depositing the mixture in air on a fabric serving as a first layer having air permeability to produce a web serving as a second layer having water absorbency; attaching a fabric serving as a third layer to a surface of the web; laminating the fabric serving as the first layer, the web, and the fabric serving as the third layer, and then heating and pressurizing to form a fabric for printing including the first layer, the second layer, and the third layer; and performing inkjet printing on the third layer of the fabric for printing.

The fabric for printing includes: the first layer having air permeability; the second layer laminated on the first layer and formed by depositing fibers and having water absorbency; and the third layer laminated on the second layer and subjected to the inkjet printing, wherein the thickness of the third layer is less than the thickness of the second layer, and the water absorbency of the second layer is higher than the water absorbency of the third layer.

### BRIEF DESCRIPTION OF THE DRAWINGS

FIG. 1 is a schematic cross-sectional view illustrating a configuration of a fabric for printing.

FIG. 2 is a schematic cross-sectional view illustrating another embodiment of the fabric for printing.

FIG. 3 is a flowchart illustrating a printing method according to an embodiment.

FIG. 4 is a schematic diagram illustrating a configuration of a fabric manufacturing apparatus.

FIG. 5 is a schematic diagram illustrating a configuration of a liquid ejection apparatus.

FIG. 6 is a schematic diagram illustrating the behavior of an ink droplet that adheres to a fabric for printing.

FIG. 7 is a schematic diagram illustrating the behavior of an ink droplet that adheres to a fabric for printing.

FIG. 8 is a schematic diagram illustrating the behavior of an ink droplet that adheres to a fabric for printing according to a comparative example.

### DESCRIPTION OF EMBODIMENTS

In the embodiments described below, a fabric for printing having a multilayer structure and a printing method using the fabric for printing will be described with reference to the drawings. In each of the following drawings, Z axis or X, Y, and Z axes, which are coordinate axes perpendicular to one another, are given as necessary, a direction indicated by an arrow is defined as a positive (+) direction, and a direction opposite to the positive direction is defined as a negative (−) direction. The Z axis is a virtual axis along the vertical direction, a +Z direction is an upward direction, and a −Z direction is a downward direction. For convenience of illustration, a size of each member is different from an actual size.

### 1. Fabric for Printing

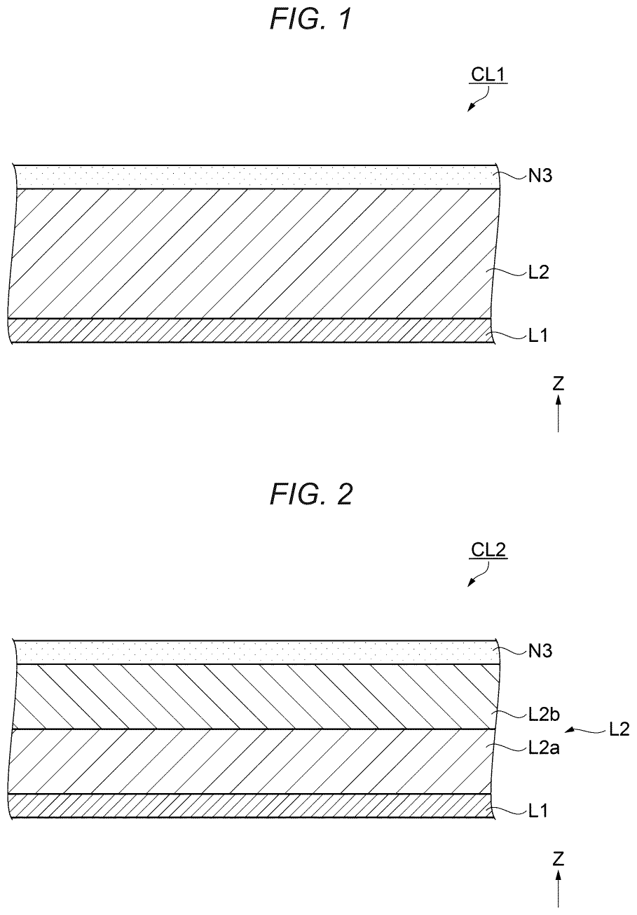

As illustrated in FIG. 1, the fabric for printing CL1 according to the embodiment has a multilayer structure including a first layer L1, a second layer L2, and a third layer L3. The fabric for printing CL1 is an example of the fabric for printing of the present disclosure, and is applied to a printing method described later.

In the fabric for printing CL1, the second layer L2 is laminated on the first layer L1, and the third layer L3 is laminated on the second layer L2. That is, the first layer L1, the second layer L2, and the third layer L3 are stacked in this order from bottom to top.

The first layer L1 has air permeability. The second layer L2 is formed by depositing fibers and has water absorbency. The third layer L3 is subjected to inkjet printing. Inkjet printing is a dyeing method using an inkjet system, in which droplets of ink or the like adhere to a fabric such as textile fabric from the nozzles of an inkjet head.

When the fabric for printing CL1 is processed into clothes or the like after printing, it is preferable to peel off the first layer L1 and the second layer L2, and to use the third layer L3 for clothes. Alternatively, the clothes may be processed in a state where the first layer L1 and the second layer L2 remain. The use of the printed fabric for printing is not limited to clothes.

Since the first layer L1 has air permeability, it is possible to promote the deposition of fibers or the like serving as the second layer L2 on the first layer L1 using the air permeability of the first layer L1 at the time of manufacturing the fabric for printing CL1. Specifically, formation of a web containing fibers is promoted by suctioning air in which fibers and the like are dispersed through the first layer L1. The manufacturing process of the fabric for printing CL1 will be described later in the section of the printing method.

In the present specification, the air permeability is defined by the amount of air passing through a test piece according to JIS air permeability test (L1096 2010 8.26.1 Method A). In the present specification, having air permeability means that the above air amount obtained by the above test method is 10 cm³/cm²·sec or more.

The first layer L1 forms one surface of the fabric for printing CL1. The first layer L1 is a fabric such as a woven fabric, a knitted fabric, or a nonwoven fabric. The first layer L1 includes, for example, polyester. According to the configuration, polyester is relatively excellent in strength, and thus the thinness and the strength of the fabric for printing CL1 can be improved. The first layer L1 is not limited to that made of polyester, but may be a fabric containing polyester and another resin, a fabric made of a resin or a material other than polyester.

In the fabric for printing CL1, the first layer L1 and the second layer L2 are bonded to each other by a bonding action of a binder which is an additive contained in the second layer L2. Details of the above additive will be described later.

The first layer L1 may include an adhesive layer on a surface bonded to the second layer L2. The adhesive layer bonds the first layer L1 and the second layer L2. Examples of the adhesive layer include known adhesive materials such as polyester resins, acrylic resins, silicone resins, and urethane resins, and known adhesives such as epoxy-based, acrylic-based, cyanoacrylate-based, urethane-based, and vinyl acetate-based adhesive agents. The adhesive layer may be cured by heating in a forming step of the manufacturing process of the fabric for printing CL1 described later.

When the adhesive layer is used, air permeability is also imparted to the adhesive layer. Specifically, the adhesive layer is formed so as not to impair the air permeability of the first layer L1. Examples of the form of the adhesive layer include a form in which the above-described adhesive material, adhesive agent, or the like is applied in a planar mesh shape, and a form having a plurality of holes penetrating in the direction along the Z axis.

When the fabric for printing CL1 is processed into clothes or the like in a state where the first layer L1 and the second layer L2 remain, the first layer L1 may be colored. A known method such as digital printing such as inkjet printing or analog printing can be applied to the coloring of the first layer L1.

The second layer L2 is a nonwoven fabric and contains a plurality of fibers obtained by defibrating a fabric or the like and an additive such as a binder. The second layer L2 is made of a web in which the plurality of fibers, additives, and the like are deposited in the air. In the following description, the plurality of defibrated fibers may be simply referred to as fibers. Although the details will be described later, the defibrating step of defibrating to obtain fibers is performed in a dry condition. In the present specification, the dry condition refers to a treatment performed not in a liquid such as water but in air such as an atmosphere.

The fibers are among the main components of the second layer L2 and affect the physical properties such as the mechanical strength of the second layer L2 together with the binder. From the viewpoint of resource circulation, it is preferable to use fibers obtained by defibrating old clothes or the like. Examples of the type of the fabric include a knitted fabric, a plain-woven fabric, and a pile fabric. The fabric may include a nonwoven fabric.

Examples of the fibers include natural fibers such as cotton, hemp, wool, silk, and regenerated cellulose, and chemical fibers such as polypropylene, polyester, and polyurethane.

As the fibers, one kind thereof is used alone, or two or more kinds thereof are used in combination. Among the above fiber materials, the fabric preferably contains natural fibers such as cotton and wool. That is, the second layer L2 preferably contains natural fibers. Since natural fibers have higher hydrophilicity than chemical fibers, the water absorbency of the second layer L2 is improved.

The weighted average fiber length of the defibrated fibers is preferably from 0.5 mm to 2.0 mm. According to this, since the fibers are not excessively shortened, the fibers are appropriately entangled with each other, and the mechanical strength of the second layer L2 is improved. The weighted average fiber length is determined by a method according to ISO 16065-2:2007.

The basis weight of the second layer L2 is preferably from 100 g/m² to 180 g/m². The basis weight is the number of grams per square meter of a plane orthogonal to the Z axis in one fabric for printing CL1. When the basis weight of the second layer L2 is within the above range, the balance between the thinness and the strength is good in the second layer L2. The basis weight of the second layer L2 is adjusted by the deposition amount of the web formed in a depositing step in the manufacture of the fabric for printing CL1, that is, the thickness of the web.

The binder bonds the fibers together in the second layer L2. A thermoplastic or thermosetting resin is used as the binder. Examples of the resin include not only thermoplastic synthetic resins such as polyester, but also natural resins such as shellac, pine resin, dammar resin, polylactic acid, plant-derived polybutylene succinate, plant-derived polyethylene, and PHBH (registered trademark) (Poly (3-hydroxybutyrate-co-3-hydroxyhexanoate)) manufactured by Kaneka Corporation. As the binder, one kind thereof is used alone, or two or more kinds thereof are used in combination.

The second layer L2 may contain an additive other than the binder. Examples of the additive other than the binder include a flame retardant, an antioxidant, an ultraviolet absorber, an aggregation inhibitor, an antibacterial agent, an antifungal agent, and the like.

The third layer L3 is laminated on the second layer L2 and attached, forming the other surface of the fabric for printing CL1. After the third layer L3 is subjected to printing as the fabric for printing CL1, the first layer L1 and the second layer L2 are peeled off, and then the third layer L3 is independently processed into clothes or the like. After the first layer L1 and the second layer L2 are peeled off, another fabric may be attached to the third layer L3 and processed into clothes or the like.

In the fabric for printing of the present disclosure, even when the amount of ink that adheres to the third layer L3 is increased due to the difference in water absorbency between the layers, the occurrence of bleeding in the resulting image or the like is suppressed. Therefore, the water absorbency of each layer of the fabric for printing CL1, which enables printing with a dark color even when the third layer L3 is a thin fabric compared to typical fabrics for printing, will be described later.

The third layer L3 is made of a fabric such as a knitted fabric or a woven fabric. The third layer L3 may be a nonwoven fabric. Examples of the fibers constituting the third layer L3 include natural fibers such as cotton, hemp, wool, silk, and regenerated cellulose, and chemical fibers such as polypropylene, polyester, and polyurethane. As the fibers, one kind thereof is used alone, or two or more kinds thereof are used in combination. In particular, natural fibers that have relatively high water absorbency, which are likely to bleed in typical printing, are suitable as the fabric of the third layer L3.

The third layer L3 may be colored at the stage of the fabric. That is, in the printing of the fabric for printing CL1, the third layer L3 is subjected to printing, but the fabric serving as the third layer L3 may be dyed with the ground color in advance before the fabric for printing CL1 is manufactured.

In the fabric for printing CL1, the third layer L3 and the second layer L2 are bonded to each other by a bonding action of a binder contained in the second layer L2. The third layer L3 may include an adhesive layer on a surface to be bonded to the second layer L2. The adhesive layer bonds the third layer L3 and the second layer L2. As the adhesive layer, the same material as that of the first layer L1 is applicable.

In the fabric for printing CL1, the water absorbency of the second layer L2 is higher than the water absorbency of the third layer L3. Accordingly, the ink applied to the third layer L3 is more likely to permeate into the second layer L2 through the third layer L3 during printing the fabric for printing CL1. Therefore, the occurrence of ink bleeding in the third layer L3 is further suppressed, and the amount of ink that adheres to the fabric for printing CL1 can be further increased.

In the present specification, water absorbency is defined by a water absorbency evaluation index calculated using the following Equation (1), based on the maximum water absorption rate V [ml/s] measured according to the JIS testing methods for water absorbency of textiles (L-1907-7.3 surface absorption method) and the water absorption amount W [ml] at the time of maximum water absorption. In the present specification, having water absorbency means that the water absorbency evaluation index is 950 or higher.

$$Water absorbency evaluation index = 2545 V + 1411 W + 79 \qquad ( 1 )$$

The water absorbency of the first layer L1 is preferably higher than the water absorbency of the third layer L3. Accordingly, the ink applied to the third layer L3 is more likely to permeate into the first layer L1 through the third layer L3 and the second layer L2 during printing the fabric for printing CL1. Therefore, the occurrence of ink bleeding in the third layer L3 is further suppressed, and the amount of ink that adheres to the fabric for printing CL1 can be further increased. In order to make the water absorbency of the first layer L1 higher than the water absorbency of the third layer L3, for example, the thickness of the first layer L1 may be greater than the thickness of the third layer L3, and the content of natural fibers such as cotton in the first layer L1 may be increased.

The content of the fibers in the second layer L2 is preferably 65 mass % or more and 85 mass % or less with respect to the total amount of the second layer L2. When the content of the fibers is 65 mass % or more, the water absorbency of the second layer L2 is improved, and the occurrence of ink bleeding in the third layer L3 is further suppressed. When the content of the fibers is 85 mass % or less, the mechanical strength of the second layer L2 is improved.

The thickness of the fabric for printing CL1 is not particularly limited, but is, for example, from 0.30 mm to 1.50 mm. The thickness of the first layer L1 is, for example, from 0.01 mm to 0.20 mm. The thickness of the second layer L2 is, for example, from 0.20 mm to 0.80 mm. The thickness of the third layer L3 is, for example, from 0.01 mm to 0.20 mm. In particular, the thickness of the third layer L3 is preferably less than the thickness of the second layer L2. According to the configuration, when the third layer L3 is processed into clothes or the like, touch, texture, comfort, and the like are improved. In addition, in the fabric for printing CL1 of the present embodiment, even when the third layer L3 is a thin fabric, the amount of ink during printing can be increased, and thus the color developability is improved.

The fabric for printing of the present disclosure may have a form different from the fabric for printing CL1. The fabric for printing CL2 exemplified below is an example of the fabric for printing of the present disclosure. The fabric for printing CL2 is different from the fabric for printing CL1 in the configuration of the second layer L2. In the description of the fabric for printing CL2, the same signs are used for the same configurations as those of the fabric for printing CL1, and the overlapping description will be omitted.

As illustrated in FIG. 2, the second layer L2 of the fabric for printing CL2 has a multilayer structure including an upper layer L2b and a lower layer L2a. In the second layer L2, the lower layer L2a and the upper layer L2b are stacked in this order from bottom to top. The fabric for printing CL2 is different from the fabric for printing CL1 in which the second layer L2 is a single layer, in this respect.

The water absorbency of the lower layer L2a is higher than the water absorbency of the upper layer L2b. Accordingly, the ink that permeated into the second layer L2 through the third layer L3 is more likely to permeate from the upper layer L2b into the lower layer L2a during printing of the fabric for printing CL2. Therefore, the water absorbency of the second layer L2 is further improved, and the occurrence of ink bleeding in the third layer L3 is further suppressed.

### 2. Printing Method

The printing method of the present disclosure includes a manufacturing process of a fabric for printing and a printing step using the fabric for printing. Hereinafter, the manufacturing process and the printing step of the fabric for printing CL1 described above will be exemplified as the printing method of the present disclosure. The printing method of the fabric for printing CL1 is an example, and is not limited to the following configuration and order.

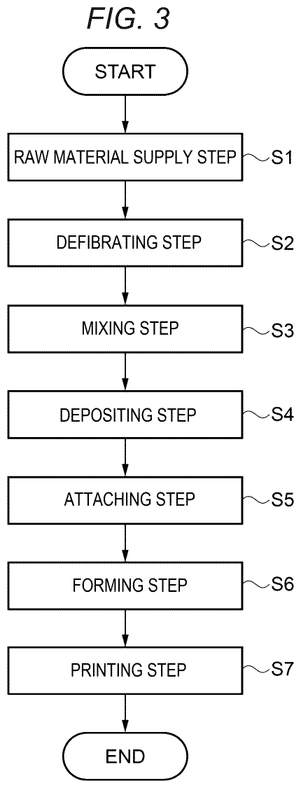

As illustrated in FIG. 3, the printing method of the fabric for printing CL1 includes a raw material supply step S1, a defibrating step S2, a mixing step S3, a depositing step S4, an attaching step S5, and a forming step S6, which are manufacturing processes of the fabric for printing CL1, and a printing step S7 using the fabric for printing CL1. In the manufacturing process of the fabric for printing CL1, the fabric for printing CL1 is manufactured through the respective steps in the above order from the upstream raw material supply step S1 to the downstream forming step S6.

A specific example of a printing method of the fabric for printing CL1 will be described together with a fabric manufacturing apparatus 1 that manufactures the fabric for printing CL1 and a liquid ejection apparatus 2 that is an inkjet printer. In the fabric manufacturing apparatus 1 and the liquid ejection apparatus 2, the end in the transport direction of a raw material, a fabric, a web, the fabric for printing CL1, and the like may be referred to as downstream, and the opposite side to the conveyance direction may be referred to as upstream. The fabric manufacturing apparatus 1 and the liquid ejection apparatus 2 are examples, and are not limited to the following configurations.

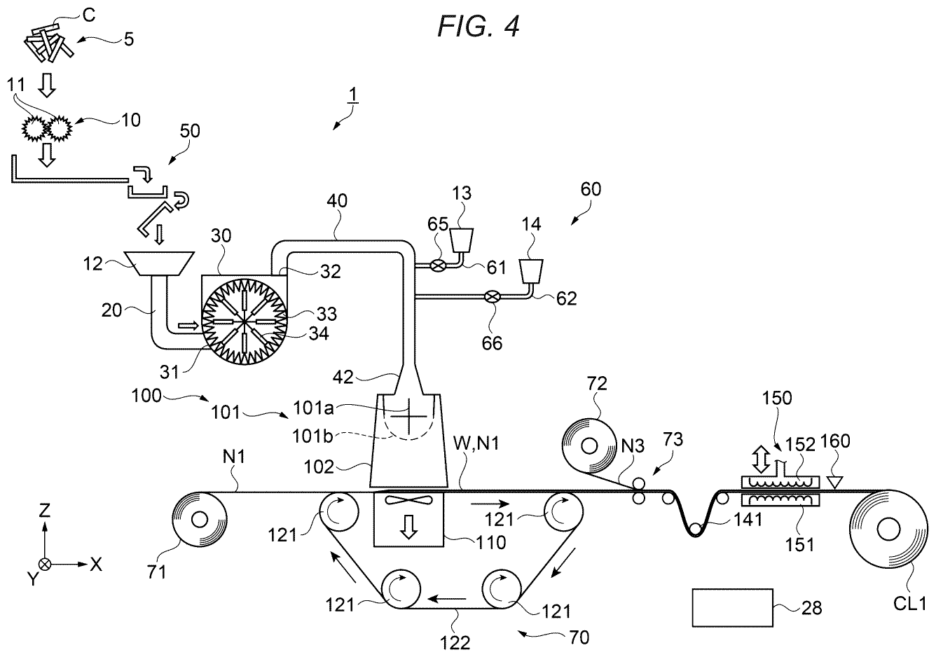

As illustrated in FIG. 4, the fabric manufacturing apparatus 1 includes a supply unit 5, a crushing unit 10, a defibrating unit 30, a mixing unit 60, a depositing unit 100, a web transport unit 70, an attaching unit 73, a forming unit 150, a cutting unit 160, and the like from upstream to downstream. The fabric manufacturing apparatus 1 also includes a control unit 28 that integrally controls the operation of each of the above configurations.

The raw material supply step S1 is performed by the supply unit 5. The supply unit 5 supplies a raw material C to the crushing unit 10. The supply unit 5 includes, for example, an automatic feeding mechanism (not illustrated), and continuously and automatically feeds the raw material C into the crushing unit 10. The raw material C is a fabric of used clothes or the like.

The crushing unit 10 shreds the raw material C, which is a fabric supplied from the supply unit 5, into small pieces in an atmosphere such as air. The crushing unit 10 is a shredder, a cutter mill, or the like having crushing blades 11. The raw material C is shredded by the crushing blades 11 into small pieces of the raw material C. The planar shape of the small piece is, for example, a several-millimeter-square shape or an irregular shape. The small pieces are collected in a fixed quantity feed unit 50. The raw material C may be shredded in advance before being fed into the supply unit 5.

The fixed quantity feed unit 50 measures the small pieces of the raw material C and feeds a fixed quantity to a hopper 12. The fixed quantity feed unit 50 is, for example, a vibration feeder. The small pieces of the raw material C fed to the hopper 12 are transported within a pipe 20 and reach an introduction port 31 of the defibrating unit 30. Then, the process proceeds to the defibrating step S2.

The defibrating step S2 is performed in the defibrating unit 30. The defibrating unit 30 defibrates the small pieces derived from the raw material C in a dry condition to produce and extract fibers contained in the raw material C. The defibrating unit 30 includes the introduction port 31, an ejection port 32, a stator 33, a rotor 34, and an airflow generation mechanism (not illustrated). The small pieces of the raw material C are introduced into the defibrating unit 30 via the introduction port 31 by the airflow of the airflow generation mechanism.

The stator 33 and the rotor 34 are disposed inside the defibrating unit 30. The stator 33 has a substantially cylindrical inner surface. The rotor 34 rotates along the inner surface of the stator 33. The small pieces of the raw material C are sandwiched between the stator 33 and the rotor 34 and are defibrated by a shearing force generated therebetween.

The fibers produced by the defibrating unit 30 are ejected from the ejection port 32 into a pipe 40. The pipe 40 communicates with the inside of the defibrating unit 30 and the inside of the depositing unit 100. The fibers are transported from the defibrating unit 30 to the depositing unit 100 by the airflow generated by the airflow generating mechanism. The mixing unit 60 is provided in the pipe 40 between the defibrating unit 30 and the depositing unit 100.

Although not illustrated, the fabric manufacturing apparatus 1 may include a sorting mechanism that removes impurities and the like contained in the defibrated fibers between the defibrating unit 30 and the mixing unit 60. Examples of the sorting mechanism include known devices such as a sieve. According to the sorting mechanism, the content of impurities is reduced, and fibers having high purity can be used as the material of the second layer L2. Then, the process proceeds to the mixing step S3.

The mixing step S3 is performed in the mixing unit 60. The mixing unit 60 mixes the fibers obtained in the defibrating step S2 with an additive, such as the binder described above, to produce a mixture. The mixing unit 60 includes hoppers 13, 14, supply pipes 61, 62, and valves 65, 66. In the mixing unit 60, the fibers, the binder, and the like are mixed in the air to form a mixture. The mixture preferably contains no coloring material. The phrase “contains no coloring material” means that a coloring material such as a pigment is not intentionally added to the mixture. That is, the mixture may contain a coloring material such as a dye permeating the fibers or a coloring material unintentionally mixed.

The hopper 13 communicates with the inside of the pipe 40 via the supply pipe 61. In the supply pipe 61, the valve 65 is provided between the hopper 13 and the pipe 40. The hopper 13 supplies the binder into the pipe 40. The valve 65 adjusts the mass of the binder supplied from the hopper 13 to the pipe 40. Thus, the mixing ratio of the fibers and the binder is adjusted. The binder may be supplied in the form of powder or particles, or may be melted and supplied.

The hopper 14 communicates with the inside of the pipe 40 via the supply pipe 62. In the supply pipe 62, the valve 66 is provided between the hopper 14 and the pipe 40. The hopper 14 supplies an additive other than the binder into the pipe 40. The valve 66 adjusts the mass of the additive other than the binder supplied from the hopper 14 to the pipe 40. Thus, the mixing ratio of the above additive to the fibers and the binder is adjusted. Note that the additive other than the binder may be mixed with the binder in advance and supplied from the hopper 13. When the additive other than the binder is not added to the mixture, the hopper 14, the supply pipe 62, and the valve 66 may be omitted.

The content of the fibers in the second layer L2 is adjusted by the mixing ratio of the fibers and the additive in the mixing step S3. Specifically, in the web W, the mass ratio of the fibers to the additive such as the binder is in the range of 9:1 to 5:5 in terms of the fiber-to-binder. In particular, as described above, in order to improve the water absorbency and the mechanical strength of the second layer L2, the content of the fibers in the web W is preferably from 65 mass % to 85 mass %.

The fibers, the binder, and the like are mixed while being transported through the pipe 40 to the depositing unit 100 to form a mixture. In order to promote the production of the mixture in the pipe 40 and improve the transportability of the mixture, a blower or the like that generates an air flow may be disposed in the pipe 40. The mixture is introduced from the pipe 40 into the depositing unit 100 via a coupling portion 42. Then, the process proceeds to the depositing step S4.

The depositing step S4 is performed in the depositing unit 100. The depositing unit 100 deposits the mixture on a fabric N1 having air permeability in the air to produce the web W serving as the second layer L2. The fabric N1 forms the first layer L1 of the fabric for printing CL1. That is, the web W is formed by depositing a mixture containing the defibrated fibers and the additive on the fabric N1 serving as the first layer L1 in the air. This makes it easy to form the web W and change the basis weight.

The depositing unit 100 includes a drum unit 101, a housing unit 102 that houses the drum unit 101, and a fabric supply unit 71 that supplies the fabric N1. The depositing unit 100 takes the mixture into the drum unit 101 from the pipe 40. Then, the mixture is deposited in a dry condition on the fabric N1 supplied from the fabric supply unit 71.

The web transport unit 70 including a mesh belt 122 and a suction mechanism 110 is disposed below the depositing unit 100. The suction mechanism 110 is disposed to face the drum unit 101 with the mesh belt 122 in between in the direction along the Z axis.

The drum unit 101 includes a blade member 101a rotationally driven by a motor (not illustrated), and a substantially cylindrical sieve portion 101b disposed to mainly cover the lower side of the blade member 101a. The blade member 101a loosens the entangled fibers while rotating. The sieve portion 101b allows particles such as fibers or a mixture smaller than the size of the mesh of the sieve to pass from the inside to the outside. As a result, in the mixture, the fibers entangled in the drum unit 101 are loosened and dispersed in the air in the housing unit 102.

The fabric supply unit 71 continuously feeds the rolled fabric N1 onto the mesh belt 122. When the fabric N1 having an adhesive layer is used, the adhesive layer of the fabric N1 faces upward. Accordingly, the adhesive layer and the web W come into contact with each other. The fabric N1 may be colored in advance.

The mixture containing the fibers is dispersed from the inside of the sieve portion 101b into the air in the housing unit 102. Then, the mixture containing the fibers is randomly deposited onto the fabric N1 being transported on the mesh belt 122. Therefore, the fibers are less likely to be oriented in a specific direction in the web W.

The sieve portion 101b may not have a function of sorting large fibers and the like in the mixture. That is, the drum unit 101 may loosen the fibers of the mixture and release the entire mixture into the housing unit 102. The mixture dispersed in the air in the housing unit 102 is deposited onto the upper surface of the fabric N1 by gravity and the suction force of the suction mechanism 110.

The basis weight of the fabric for printing CL1 is adjusted by the basis weight of the fabric N1, the fabric N3 described later, and the web W. The basis weight of the web W is adjusted by the number of rotations of the blade member 101a, the supply amount per unit time of the mixture to the depositing unit 100, the transport speed of the fabric N1 by the mesh belt 122, and the like.

Here, in the depositing step S4, the thickness of the second layer L2 of the fabric for printing CL1 may be adjusted by changing the thickness of the web W. The thickness of the second layer L2 can be adjusted by the basis weight of the web W, the pressure during pressurization in the forming step S6, and the like.

The web transport unit 70 includes the mesh belt 122 and the suction mechanism 110. The web transport unit 70 promotes the deposition of the mixture on the fabric N1 by the suction mechanism 110. Further, the web transport unit 70 transports the web W formed of the mixture downstream by the rotation of the mesh belt 122.

The suction mechanism 110 is disposed below the drum unit 101. The suction mechanism 110 suctions the air in the housing unit 102 through a plurality of holes of the mesh belt 122 and the fabric N1 having air permeability. Accordingly, the mixture released to the outside of the drum unit 101 is suctioned downward together with the air and deposited onto the upper surface of the fabric N1. A known suction device such as a blower is adopted as the suction mechanism 110.

Air passes through the plurality of holes of the mesh belt 122, but the fibers, the binder, and the like contained in the mixture are hard to pass though the holes. The mesh belt 122 is an endless belt and is looped with tension by four tension rollers 121.

The upper surface of the mesh belt 122 moves downstream by the rotation of the tension rollers 121 themselves. In other words, the mesh belt 122 rotates clockwise in FIG. 4. When the mesh belt 122 is rotated by the tension rollers 121, the mixture is continuously deposited on the fabric N1 to form the web W. The web W contains a relatively large amount of air and is soft and puffed. The web W is transported downstream together with the fabric N1 as the mesh belt 122 moves. Then, the process proceeds to the attaching step S5.

A humidifier may be disposed downstream of the depositing unit 100 to spray water onto the web W for humidification. As a result, scattering of the fibers, the binder, and the like contained in the web W is suppressed. Further, the water used for humidification may contain a water-soluble additive, and the web W serving as the second layer L2 may be subjected to a surface treatment and the like in parallel with the humidification.

Here, when the above fabric for printing CL2 is manufactured, in the depositing step S4, the depositing unit 100 and another depositing unit downstream of the depositing unit 100 are disposed. Although not illustrated, first, in the depositing unit 100, a first web serving as the lower layer L2a is produced by deposition on the fabric N1 serving as the first layer L1. Then, while the fabric N1 and the first web are transported downstream, in the above other depositing unit, a second web serving as the upper layer L2b is produced by deposition on the first web.

The difference in water absorbency between the upper layer L2b and the lower layer L2a can be realized by changing the basis weight of the first web serving as the lower layer L2a and the basis weight of the second web serving as the upper layer L2b in the depositing step S4. Specifically, the basis weight of the first web is made larger than the basis weight of the second web. The basis weight corresponds to the thickness, and the thickness increases as the basis weight increases. Therefore, when the basis weight of the first web is larger than the basis weight of the second web, the ink absorption capacity of the lower layer L2a becomes larger than the ink absorption capacity of the upper layer L2b. Accordingly, the ink that has permeated the second layer L2 is more likely to further permeate from the upper layer L2b into the lower layer L2a. Therefore, the occurrence of ink bleeding in the third layer L3 is further suppressed.

In order to make the water absorbency of the lower layer L2a higher than the water absorbency of the upper layer L2b, the material of the fibers contained in each layer may be changed. Specifically, the content of natural fibers such as cotton or wool is increased in the lower layer L2a, and the content of chemical fibers such as polyester is increased in the upper layer L2b. Accordingly, the hydrophilicity of the lower layer L2a is increased with respect to the upper layer L2b, and the water absorbency of the lower layer L2a is improved with respect to the upper layer L2b.

The attaching step S5 is performed in the attaching unit 73. The fabric N3, serving as the third layer L3, is attached to the upper surface of the web W by the attaching unit 73.

The fabric N3 is supplied from the fabric supply unit 72 to the attaching unit 73. The fabric supply unit 72 continuously feeds the rolled fabric N3 onto the web W. When the fabric N3 having an adhesive layer is used, the adhesive layer is brought into contact with the upper surface of the web W.

The attaching unit 73 bonds the upper surface of the web W to the lower surface of the fabric N3. The attaching unit 73 is a pressure roller pair, and sandwiches and bonds the fabric N1, the web W, and the fabric N3 in the up-down direction under pressure. Then, the process proceeds to the forming step S6.

A dancer roller 141 is disposed between the attaching step S5 and the forming step S6. The dancer roller 141 secures the processing time of the downstream forming step S6. Specifically, the forming step S6 is batch processing. Therefore, the processing time of the forming step S6 is secured by moving the dancer roller 141 up and down with respect to the fabric N1, the web W, and the fabric N3 which are continuously transported. The fabric N1, the web W, and the fabric N3 are transported downstream via the dancer roller 141.

The forming step S6 is performed in the forming unit 150. The forming unit 150 laminates the fabric N1 serving as the first layer L1, the web W, and the fabric N3, and heats and pressurizes them to form. The forming unit 150 is a hot press device and includes an upper plate 152 and a lower plate 151. The upper plate 152 and the lower plate 151 sandwich the fabric N1, the web W, and the fabric N3 therebetween and pressurize them, and heat them by a built-in heater. In the forming step S6, the forming step S6 may be continuously performed using a heating roller pair or the like. When the heating roller pair is used, the dancer roller 141 may be omitted.

The web W is compressed in the up-down direction via the fabric N1 and the fabric N3 by pressurization, and its density increases. Then, the binder is melted by heating and wets and spreads between the fibers. When the heating is completed in this state and the binder is solidified, the fibers are bonded to each other by the binder. The fabric N1 and the fabric N3 are attached to the web W by the binder of the web W. As a result, the fabric N1 forms the first layer L1, the web W forms the second layer L2, and the fabric N3 forms the third layer L3.

The pressing conditions in the forming unit 150 are appropriately adjusted depending on a desired density and the like in the fabric for printing CL1. For example, in the forming step S6, the pressing pressure is 0.01 MPa or more. In particular, in order to improve the water absorbency of the second layer L2, the pressing pressure is preferably 0.70 MPa or less. Accordingly, the water absorbency of the second layer L2 is improved, and the occurrence of ink bleeding in the third layer L3 is further suppressed.

The heating conditions in the forming unit 150 are appropriately adjusted depending on the type, melting point, curing temperature, and the like of the binder. For example, in the forming step S6, the heating temperature is 90° C. or higher. In particular, in order to improve the water absorbency of the second layer L2, the heating temperature is preferably 140° C. or less. Accordingly, the water absorbency of the second layer L2 is improved, and the occurrence of ink bleeding in the third layer L3 is further suppressed.

In the forming unit 150, a band-shaped fabric for printing CL1 in which the fabric N1, the web W, and the fabric N3 are integrated is formed.

The cutting unit 160 is disposed downstream of the forming unit 150. The cutting unit 160 shapes the shape of the sides at both ends in the direction along the Y axis in the band-shaped fabric for printing CL1. The cutting unit 160 includes a vertical blade (not illustrated). The vertical blade cuts the band-shaped fabric for printing CL1 along the conveyance direction. Accordingly, both sides of the fabric for printing CL1 are cut and aligned.

Then, the band-shaped fabric for printing CL1 is wound into a roll to form a bolt of fabric. Through the manufacturing process described above, the fabric for printing CL1 including the first layer L1, the second layer L2, and the third layer L3 is manufactured.

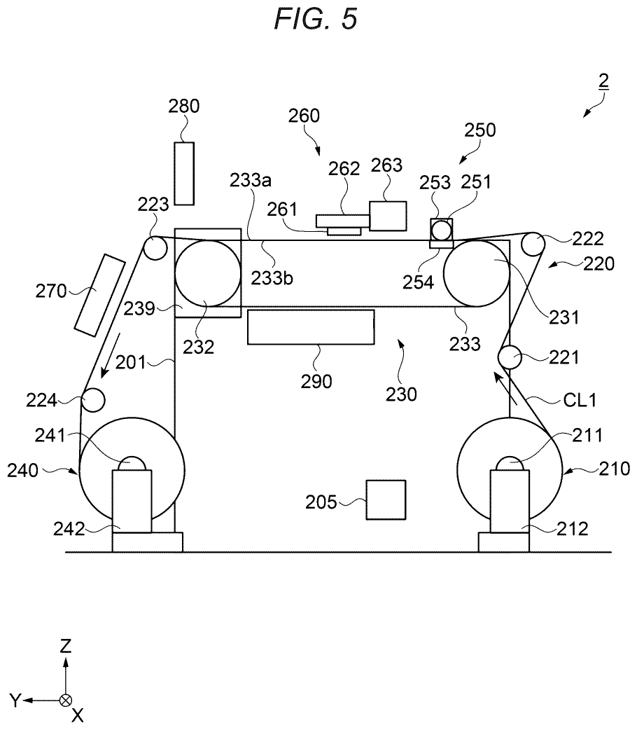

As illustrated in FIG. 5, the liquid ejection apparatus 2 includes a control unit 205, a medium transporting unit 220, a recording unit 260, a drying unit 270, a winding unit 240, an operation panel 280, and a cleaning mechanism 290. The liquid ejection apparatus 2 also includes a housing (not illustrated). Each configuration of the liquid ejection apparatus 2 is supported by a frame 201. In the description related to FIG. 5, unless otherwise specified, a state viewed from an-X direction will be described.

In the liquid ejection apparatus 2, inkjet printing is performed on the above third layer L3 of the fabric for printing CL1 as the printing step S7 of the printing method according to the present embodiment. The liquid ejection apparatus 2 manufactures a printed object by causing a water-based ink or the like to adhere to the third layer L3. The inkjet printing referred to here includes forming an image such as a text, a pattern, a picture, a photograph, or the like, in addition to coloring with a single color.

The above manufacturing process of the fabric for printing CL1 and the printing step S7 may not be continuously performed. For example, the printing step S7 may be performed on the manufactured fabric for printing CL1 after being stored, transported, or distributed.

The control unit 205 is electrically coupled to each component of the liquid ejection apparatus 2 and integrally controls an operation of each component. The control unit 205 includes hardware such as a central processing unit (CPU), a read only memory (ROM), and a random access memory (RAM). The control unit 205 executes a predetermined control program by the CPU. The ROM is a nonvolatile storage device and stores the control program to be executed by the CPU and data to be processed by the control program. The RAM configures a work area of the CPU. The CPU loads the control program read from the ROM or the like into the RAM and executes the loaded control program.

The operation panel 280 is also electrically coupled to the control unit 205. The operation panel 280 displays various types of information to a user of the liquid ejection apparatus 2 and receives an input of various operations and various settings performed by the above user. The control unit 205 also controls the liquid ejection apparatus 2 according to the information input to the operation panel 280. In the following description, the user of the liquid ejection apparatus 2 is also simply referred to as a user.

The operation panel 280 is supported by the frame 201 via a member (not illustrated), and is disposed above the liquid ejection apparatus 2 and at an end portion in a +Y direction. The user stands in the +Y direction of the liquid ejection apparatus 2 and performs various inputs while viewing the operation panel 280. The operation panel 280 is, for example, a liquid crystal display of a touch panel type. The operation panel 280 may include physical buttons in addition to the liquid crystal display.

The medium transporting unit 220 includes a medium supply unit 210, transport rollers 221, 222, 223, 224, a conveyance mechanism 230, and a winding unit 240. The medium transporting unit 220 transports the fabric for printing CL1 along a conveyance path from the upstream to the downstream.

The medium supply unit 210 includes a supply shaft 211, a bearing 212, and a rotation drive unit (not illustrated). The supply shaft 211 has a substantially cylindrical shape and holds a core of the raw fabric of the fabric for printing CL1. The bearing 212 detachably and rotatably supports both ends of the supply shaft 211 in a direction along the X axis.

The rotation drive unit is, for example, an electric motor, and rotationally drives the supply shaft 211. With the rotation of the supply shaft 211 and a belt rotating roller 232 of the conveyance mechanism 230 to be described below, the fabric for printing CL1 is unwound from the raw fabric and fed downstream.

The fabric for printing CL1 is transported from the medium supply unit 210 and passes via the transport roller 221, and a conveyance direction is changed to substantially the +Y direction by the transport roller 222. The fabric for printing CL1 is delivered to the conveyance mechanism 230 from substantially the −Y direction.

The conveyance mechanism 230 includes belt rotating rollers 231, 232, a conveyance belt 233, and a pressure bonding unit 250.

The conveyance belt 233 is located between the transport roller 222 and the transport roller 223 and transports the fabric for printing CL1. The conveyance belt 233 is an endless belt and is stretched by the belt rotating rollers 231, 232 in a region including a position facing the recording unit 260 in the up-down direction. The conveyance belt 233 has an outer peripheral surface 233a and an inner peripheral surface 233b. The outer peripheral surface 233a and the inner peripheral surface 233b are in a front-back relationship. The fabric for printing CL1 may be placed on the outer peripheral surface 233a.

The conveyance belt 233 has an adhesive layer (not illustrated). The adhesive layer has an adhesive force to the fabric for printing CL1, and the fabric for printing CL1 can be attached thereto. The adhesive layer is provided over the entire circumference of the outer peripheral surface 233a. The conveyance belt 233 is rotationally driven counterclockwise by the belt rotating roller 231, 232 in a state where the fabric for printing CL1 is attached to the adhesive layer. Accordingly, the fabric for printing CL1 is transported in the conveyance direction. The conveyance direction of the fabric for printing CL1 in the conveyance belt 233 is the +Y direction.

In the direction along the X axis, the width of the conveyance belt 233 is larger than the width of the fabric for printing CL1. A direction intersecting the conveyance direction is defined as a width direction of the conveyance belt 233. In the embodiment, the width direction of the conveyance belt 233 is a direction along the X axis.

The belt rotating rollers 231, 232 are substantially cylindrical rotation members and are paired with each other. Each of the belt rotating rollers 231, 232 is rotatable about a rotation axis along the X axis. The belt rotating roller 231 and the belt rotating roller 232 are disposed to face each other in the direction along the Y axis. The belt rotating roller 231 is disposed upstream of the conveyance mechanism 230 and near the transport roller 222 in the +Y direction. The belt rotating roller 232 is disposed downstream of the conveyance mechanism 230 and near the transport roller 223 in the −Y direction. A support member that supports the conveyance belt 233 may be disposed between the belt rotating roller 231 and the belt rotating roller 232.

The belt rotating roller 231 is a driven roller to which the rotation of the belt rotating roller 232 is transmitted via the conveyance belt 233 and which rotates counterclockwise. The belt rotating roller 231 is rotatably supported by a roller support unit (not illustrated).

The belt rotating roller 232 is rotationally driven counterclockwise by a conveyance drive motor (not illustrated). The conveyance drive motor is controlled by the control unit 205. The belt rotating roller 232 is rotatably supported by a roller support unit 239.

The fabric for printing CL1 is delivered from the transport roller 222 to the conveyance mechanism 230 and placed on the outer peripheral surface 233a of the conveyance belt 233 above the belt rotating roller 231. At this time, the fabric for printing CL1 may not be in close contact with the outer peripheral surface 233a.

The outer peripheral surface 233a supports the fabric for printing CL1 from below. The inner peripheral surface 233b is in contact with the belt rotating roller 231 and the belt rotating roller 232. The conveyance belt 233 is rotationally driven by the friction force between the inner peripheral surface 233b and the belt rotating roller 232. The belt rotating roller 231 is driven by the friction force between the inner peripheral surface 233b and the belt rotating roller 231.

In the direction along the X axis, which is a width direction of the conveyance belt 233, the width of the adhesive layer of the outer peripheral surface 233a is substantially equal to the width of the conveyance belt 233. A path of the conveyance belt 233 from the belt rotating roller 231 to the belt rotating roller 232 is a conveyance path of the fabric for printing CL1. A path in which the conveyance belt 233 is folded back by the belt rotating roller 232 toward the belt rotating roller 231 is defined as a non-conveyance path. The outer peripheral surface 233a faces upward in the conveyance path and faces downward in the non-conveyance path.

The adhesive layer of the outer peripheral surface 233a comes into close contact with the above first layer L1 of the fabric for printing CL1 by an adhesive force. The adhesive layer includes, for example, an adhesive material having an adhesive force such as a silicone resin, an acrylic resin, or a urethane resin. In the liquid ejection apparatus 2, an acrylic resin is used as a base material of the adhesive layer.

The pressure bonding unit 250 is disposed near the belt rotating roller 231 in the +Y direction. The pressure bonding unit 250 includes a pressing roller 251, a pair of support units 253, a heating unit 254, and a pair of drive units (not illustrated). The pressure bonding unit 250 compresses the fabric for printing CL1 and the adhesive layer of the conveyance belt 233 to attach the fabric for printing CL1 to the adhesive layer.

The pressing roller 251 is a substantially cylindrical rotation member. The pressing roller 251 has a rotation axis along the X axis and is disposed above the conveyance belt 233. The support units 253 are disposed at both ends of the pressing roller 251 in the direction along the X axis. The pressing roller 251 is rotatably supported by the pair of support units 253. Each of the pair of support units 253 is supported by the drive unit. In the direction along the X axis, the length of the pressing roller 251 is substantially equal to the width of the conveyance belt 233.

One of the drive units is further disposed at a position in the −X direction with respect to the support unit 253 that supports an end portion of the pressing roller 251 in the −X direction. The other one of the drive units is further disposed at a position in the +X direction with respect to the support unit 253 that supports an end portion of the pressing roller 251 in the +X direction.

The pair of drive units move in the up-down direction while supporting the pair of support units 253 by an elevation drive motor (not illustrated). Therefore, the pressing roller 251 can be displaced in the up-down direction while being supported by the support unit 253. Accordingly, the strength of the pressing force with which the pressing roller 251 presses the fabric for printing CL1 against the adhesive layer of the outer peripheral surface 233a is adjusted.

Although not illustrated, the pair of drive units also reciprocate in the direction along the Y axis while supporting the pair of support units 253 by driving the guide member and the motor. Therefore, the pressing roller 251 is supported by the support unit 253 and can reciprocate in the direction along the Y axis.

The heating unit 254 heats the conveyance belt 233. The heating unit 254 is disposed below the pressing roller 251 via the conveyance belt 233. An upper surface of the heating unit 254 is formed in a substantially planar shape and is in contact with the lower inner peripheral surface 233b of the conveyance belt 233 in the conveyance path. The distance of the heating unit 254 in the direction along the Y axis is substantially equal to the distance by which the pressing roller 251 reciprocates in the conveyance direction and the reverse conveyance direction. The distance of the heating unit 254 in the direction along the X axis is substantially equal to the width of the conveyance belt 233 in the direction along the X axis.

The heating unit 254 is, for example, an electric heater. The adhesive layer on the outer peripheral surface 233a of the conveyance belt 233 is heated by the heating of the heating unit 254. The flexibility of the adhesive layer is increased by heating, and the adhesive force to the fabric for printing CL1 is increased. The heating temperature by the heating unit 254 is, for example, from 35° C. to 60° C. on the upper surface of the heating unit 254.

In the pressure bonding unit 250, the fabric for printing CL1 is placed onto the upper surface of the heating unit 254 via the conveyance belt 233. The heating unit 254 heats the conveyance belt 233, and the pressing roller 251 presses the fabric for printing CL1 against the adhesive layer from above. In parallel with this, the pressing roller 251 reciprocates in the +Y direction and the −Y direction while rotating. The fabric for printing CL1 and the conveyance belt 233 are sandwiched and pressed between the upper surface of the heating unit 254 and the pressing roller 251, and the fabric for printing CL1 and the outer peripheral surface 233a come into close contact with each other.

The fabric for printing CL1 is transported in the +Y direction via the pressure bonding unit 250 while being in close contact with the conveyance belt 233. Instead of the heating unit 254, the pressing roller 251 may have a function of heating the conveyance belt 233. The heating unit 254 may be omitted depending on the type of the fabric for printing CL1 and the characteristics of the adhesive layer.

As a configuration in which the pressing roller 251 has a function of heating the conveyance belt 233, the following heat roller system is exemplified. The heat roller system includes a support plate having substantially the same shape as the heating unit 254, a heat roller having the same shape as the pressing roller 251, a pair of support units 253, and a pair of drive units. That is, the heat roller system operates in the same manner as the pressure bonding unit 250 except that the heat roller has a heating function of the heating unit 254.

The recording unit 260 faces the outer peripheral surface 233a and the fabric for printing CL1 in the up-down direction in the middle of the conveyance belt 233 in the direction along the Y axis. The recording unit 260 performs recording by ejecting ink or the like onto the fabric for printing CL1 transported by the conveyance belt 233, causing it to adhere. Thus, the fabric for printing CL1 is subjected to printing. The recording unit 260 includes an ejection unit 261, which is an inkjet head, a carriage 262, and a guide rail 263.

The guide rail 263 is a structural member extending along the X axis, and is disposed above the conveyance mechanism 230. The guide rail 263 supports the carriage 262 such that the carriage 262 is movable in the direction along the X axis. The carriage 262 is supported by the guide rail 263 and reciprocates in the direction along the X axis by driving of a carriage drive motor (not illustrated). The ejection unit 261 is attached below the carriage 262 and reciprocates in the direction along the X axis with respect to the conveyance belt 233 together with the carriage 262.

The ejection unit 261 ejects ink or the like onto the fabric for printing CL1, which is placed on and transported by the outer peripheral surface 233a, causing it to adhere. The ejection unit 261 has a nozzle surface (not illustrated) at a position facing downward. The nozzle surface faces the conveyance belt 233 and the fabric for printing CL1 in the up-down direction. A plurality of nozzle rows are disposed on the nozzle surface. Each of the plurality of nozzle rows includes a plurality of nozzles. Each of the plurality of nozzle rows individually ejects a plurality of types of inks exhibiting colors such as cyan, magenta, yellow, black, and the like onto the above third layer L3 of the fabric for printing CL1. In the present embodiment, a water-based pigment ink is used as the ink.

In the ejection unit 261, a piezoelectric element is used as an actuator which is a drive unit. The drive unit is not limited thereto. As the drive unit, for example, electromechanical conversion elements that displace vibrating plates as the actuators with electrostatic adsorption, or electrothermal conversion elements that eject the ink as droplets using air bubbles generated by heating may be applied.

Although not illustrated, the ink is supplied from each ink tank to the ejection unit 261 via an ink pipe. The ink ejected from the ejection unit 261 adheres to the surface of the fabric for printing CL1 facing upward, that is, the third layer L3 described above.

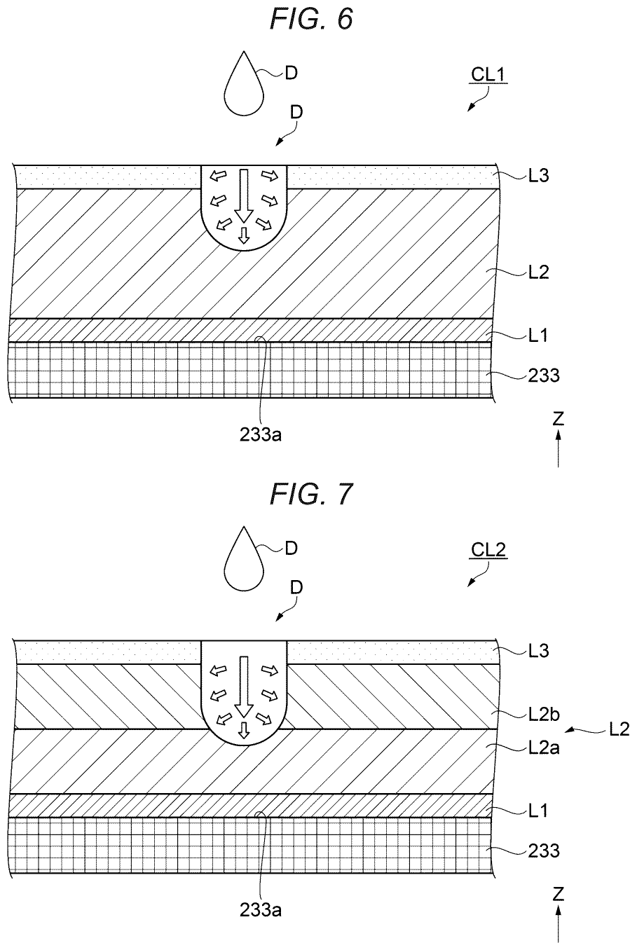

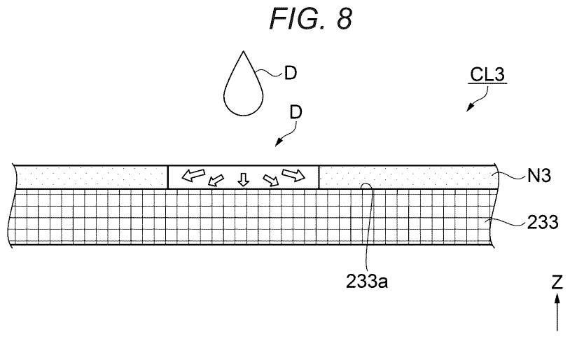

Here, the behavior of the ink droplet adhering to the fabric for printing CL1 and the like will be described. As illustrated in FIG. 8, a typical fabric for printing CL3 as a comparative example has a single-layer structure made of the fabric N3. When printing is performed on the fabric for printing CL3, the fabric N3 as the fabric for printing CL3 is in close contact with the outer peripheral surface 233a of the conveyance belt 233. Here, in FIG. 8 and FIGS. 6, 7 described later, the permeation direction of the ink droplet D is indicated by a white arrow. The size of the arrow schematically represents the amount of permeating ink.

The ink droplet D ejected onto the fabric for printing CL3 lands onto the upper surface of the fabric for printing CL3 and penetrates into the fabric for printing CL3. At this time, when the fabric N3 is a thin fabric, the ink cannot sufficiently permeate into the −Z direction. That is, in the fabric for printing CL3, the ink penetration capacity is small, and the ink penetrates relatively quickly in the −Z direction, reaching saturation. In addition, the ink is less likely to permeate into the conveyance belt 233. Therefore, in the fabric for printing CL3, the ink droplet D is more likely to permeate into the direction intersecting the Z axis. As a result, permeation of the ink droplet D in the lateral direction, that is, wetting and spreading, is prominent. As a result, in the typical fabric for printing CL3, when the amount of ink to be adhered is increased, ink bleeding is likely to occur.

Compared to the typical fabric for printing CL3, the fabrics for printing CL1, CL2 of the embodiment improve the water absorbency in the-Z direction and suppress the occurrence of bleeding.

As illustrated in FIG. 6, the ink droplet D landed on the fabric for printing CL1 permeates mainly in the −Z direction even when the fabric N3 which is the third layer L3 is a thin fabric. This is derived from the difference in water absorbency between the third layer L3 and the second layer L2 in addition to the fact that the fabric for printing CL1 has a multilayer structure. Accordingly, the ink droplet D is less likely to wet and spread in the lateral direction than the above fabric for printing CL3. Therefore, in the fabric for printing CL1, even when the amount of ink to be adhered is increased, ink bleeding is less likely to occur.

As illustrated in FIG. 7, the ink droplet D landed on the fabric for printing CL2 permeates mainly in the −Z direction even when the fabric N3 which is the third layer L3 is a thin fabric. This is derived from the difference in water absorbency between the third layer L3, the upper layer L2b, and the lower layer L2a in addition to the fact that the fabric for printing CL2 has a multilayer structure. Accordingly, the ink droplet D is even less likely to wet and spread in the lateral direction than the above fabric for printing CL1. Therefore, in the fabric for printing CL2, even when the amount of ink to be adhered is increased, ink bleeding is even less likely to occur.

Returning to FIG. 5, the fabric for printing CL1 is transported in the +Y direction by the conveyance belt 233 while reciprocating the ejection unit 261 in the direction along the X axis. At this time, ink or the like adheres to the fabric for printing CL1 from the ejection unit 261 at a predetermined timing. Accordingly, a desired image or the like is formed on the fabric for printing CL1.

The functional liquid may be applied to the fabric for printing CL1 before, after, or simultaneously with the application of ink to the fabric for printing CL1. Examples of the functional liquid include a softener that improves the texture of printed object, and a treatment liquid that improves the abrasion resistance, washing fastness, and the like of printed object. The functional liquid may be ejected from the ejection unit 261 in the same manner as the ink, or may be applied to the fabric for printing CL1 by a device different from the ejection unit 261.

In the ejection unit 261, preliminary ejection is performed at a stage before the ejection of the ink to the fabric for printing CL1, between the ejections, and the like. The preliminary ejection is performed for purposes such as prevention of drying and fixation of the ink at a gas-liquid interface in each nozzle of the ejection unit 261 and prevention of color mixture after cleaning of each nozzle. The preliminary ejection is performed under the control of the control unit 205. The timing of performing the preliminary ejection, the time interval, the amounts of ink to be preliminarily ejected, and the like are appropriately set according to the types and characteristics of the ink.

The fabric for printing CL1 subjected to printing is further transported in the +Y direction from a position facing the recording unit 260. Then, the fabric for printing CL1 is peeled off from the conveyance belt 233 substantially above the belt rotating roller 232, and is delivered to the transport roller 223 downstream of the belt rotating roller 232.

The conveyance belt 233 is folded back from the conveyance path to the non-conveyance path by the belt rotating roller 232, and moves in the −Y direction in a state where the outer peripheral surface 233a faces downward.

The cleaning mechanism 290 cleans the adhesive layer of the conveyance belt 233. The cleaning mechanism 290 is disposed on a lower side of the conveyance belt 233, which corresponds to the non-conveyance path, and faces the outer peripheral surface 233a in the up-down direction. Ink and dirt such as lint and foreign matter from the fabric for printing CL1 are likely to adhere to the adhesive layer of the outer peripheral surface 233a because the adhesive layer is provided, the fabric for printing CL1 is transported in close contact with the adhesive layer, the preliminary ejection is performed, and the like. Therefore, the adhesive layer is kept clean by cleaning with the cleaning mechanism 290.

A known cleaning device can be applied to the cleaning mechanism 290. Examples of the cleaning device include a cleaning device including a cleaning tank and a cleaning brush. In such a cleaning device, a cleaning liquid such as water stored in the cleaning tank is applied to the cleaning brush, and dirt on the adhesive layer is scraped off by the cleaning brush.

After being cleaned by the cleaning mechanism 290, the conveyance belt 233 is folded back from the non-conveyance path to the conveyance path by the belt rotating roller 231, and moves in the +Y direction in a state where the outer peripheral surface 233a faces upward. In this way, the conveyance belt 233 rotates counterclockwise.

The transport roller 223 peels off the printed object, which is the fabric for printing CL1 subjected to printing, from the conveyance belt 233. The printed object peeled off from the conveyance belt 233 is transported substantially in the +Y direction, and the conveyance direction is changed substantially downward by the transport roller 223. The transport rollers 223,224 relay the printed object to the winding unit 240.

The drying unit 270 is disposed between the transport roller 223 and the transport roller 224. The drying unit 270 dries the ink adhered to the printed object. The drying unit 270 includes, for example, an infrared heater. Volatile components contained in the ink adhered to the printed object are volatilized by the infrared rays radiated by the infrared heater. Accordingly, the above ink droplet D is dried, and the printed object can be wound by the winding unit 240. The printed object proceeds to the winding unit 240 via the transport roller 224.

The winding unit 240 is disposed downstream of and below the transport roller 224. The winding unit 240 collects the printed object. The winding unit 240 includes a winding shaft 241, a bearing 242, and a rotation drive unit (not illustrated). The winding shaft 241 has a substantially cylindrical shape and winds the printed object in a roll shape. The bearing 242 rotatably supports both ends of the winding shaft 241 in the direction along the X axis. The winding shaft 241 can be attached to and detached from the bearing 242. The rotation drive unit rotates the winding shaft 241 counterclockwise. The winding shaft 241 is rotated by the rotation drive unit, and the printed object is wound. As described above, the above printing step S7 is performed, and the printed object is manufactured from the fabric for printing CL1.

According to the present embodiment, the following effects can be obtained.

The color developability of a thin fabric can be improved. Specifically, the ink adhered to the third layer L3 in the printing step S7 permeates into the third layer L3 and further permeates into the second layer L2. That is, since the permeation component of the ink also permeates in the −Z direction which is the thickness direction of the fabrics for printing CL1, CL2, the permeation in the lateral direction intersecting the Z axis is reduced. Accordingly, since the occurrence of bleeding is suppressed even when the third layer L3 is a thin fabric, it is possible to increase the amount of ink adhered to the fabrics for printing CL1, CL2. Therefore, it is possible to provide a printing method that improves the color developability of a thin fabric. In addition, it is possible to provide the fabrics for printing CL1 and CL2 having improved color developability.

Contents derived from the embodiments are described below.

A printing method includes: defibrating a fabric in a dry condition to produce fibers; mixing an additive with the fibers obtained in the defibrating to produce a mixture; depositing the mixture in air on a fabric serving as a first layer having air permeability to produce a web serving as a second layer having water absorbency; attaching a fabric serving as a third layer to a surface of the web; laminating the fabric serving as the first layer, the web, and the fabric serving as the third layer, and then heating and pressurizing to form a fabric for printing including the first layer, the second layer, and the third layer; and performing inkjet printing on the third layer of the fabric for printing.

With this configuration, the color developability of a thin fabric can be improved. Specifically, the ink adhered to the third layer in the printing step permeates into the third layer and further permeates into the second layer. That is, since the permeation component of the ink also permeates in the thickness direction of the fabric for printing, the permeation in the lateral direction intersecting the thickness direction is reduced. Accordingly, since the occurrence of bleeding is suppressed even when the third layer is a thin fabric, it is possible to increase the amount of ink adhered to the fabric for printing. Therefore, it is possible to provide a printing method that improves the color developability of a thin fabric.

In the above printing method, the water absorbency of the second layer is higher than the water absorbency of the third layer.

According to this configuration, in the printing step, the ink adhered to the third layer is more likely to permeate into the second layer through the third layer. Therefore, the occurrence of ink bleeding in the third layer is further suppressed, and the amount of ink to be adhered can be further increased.

In the above printing method, the water absorbency of the first layer is higher than the water absorbency of the third layer.

According to this configuration, in the printing step, the ink adhered to the third layer is also likely to be absorbed into the first layer through the third layer and the second layer. Therefore, the occurrence of ink bleeding in the third layer is further suppressed, and the amount of ink to be adhered can be further increased.

In the above printing method, the fabric contains natural fibers.

According to this configuration, natural fibers have higher hydrophilicity than chemical fibers. Therefore, the water absorbency of the second layer is improved, and the occurrence of ink bleeding in the third layer is further suppressed.

In the above printing method, the content of the fibers in the second layer is from 65 mass % to 85 mass % with respect to the second layer.

According to this configuration, when the content of the fibers is 65 mass % or more, the water absorbency of the second layer is improved, and the occurrence of ink bleeding in the third layer is further suppressed. When the content of the fibers is 85 mass % or less, the mechanical strength of the second layer is improved.

In the above printing method, the heating temperature is 140° C. or less in the forming step.

According to this configuration, the water absorbency of the second layer is improved, and the occurrence of ink bleeding in the third layer is further suppressed.

In the above printing method, the pressing pressure is 0.70 MPa or less in the forming step.

According to this configuration, the water absorbency of the second layer is improved, and the occurrence of ink bleeding in the third layer is further suppressed.

In the above printing method, the second layer includes a lower layer and an upper layer, and in the depositing step, a first web serving as the lower layer is produced on the fabric serving as a first layer, a second web serving as the upper layer is produced on the first web, and the water absorbency of the lower layer is higher than the water absorbency of the upper layer.

According to this configuration, the ink absorbed by the second layer is likely to be absorbed from the upper layer to the lower layer. Therefore, the water absorbency of the second layer is further improved, and the occurrence of ink bleeding in the third layer is further suppressed.

In the above printing method, the basis weight of the first web is larger than the basis weight of the second web.

According to this configuration, the ink permeated into the second layer is more likely to further permeate from the upper layer into the lower layer. Therefore, the occurrence of ink bleeding in the third layer is further suppressed.

The fabric for printing includes a first layer having air permeability, a second layer that is laminated on the first layer, is formed by depositing fibers, and has water absorbency, and a third layer that is laminated on the second layer and is subjected to inkjet printing, wherein the thickness of the third layer is less than the thickness of the second layer, and water absorbency of the second layer is higher than the water absorbency of the third layer.

With this configuration, the color developability of a thin fabric can be improved. Specifically, in the printing step, the ink adhered to the third layer is likely to permeate from the third layer into the second layer. That is, since the permeation component of the ink also permeates in the thickness direction of the fabric for printing, the permeation in the lateral direction intersecting the thickness direction is reduced. Accordingly, since the occurrence of bleeding is suppressed even when the third layer is a thin fabric, it is possible to increase the amount of ink adhered to the fabric for printing. Therefore, it is possible to provide a fabric for printing that improves the color developability.

What is claimed is:

1. A printing method comprising:
defibrating a fabric in a dry condition to produce fibers;
mixing an additive with the fibers obtained in the defibrating to produce a mixture;
depositing the mixture in air on a fabric serving as a first layer having air permeability to produce a web serving as a second layer having water absorbency;
attaching a fabric serving as a third layer to a surface of the web;
laminating the fabric serving as the first layer, the web, and the fabric serving as the third layer, and then heating and pressurizing to form a fabric for printing including the first layer, the second layer, and the third layer; and
performing inkjet printing on the third layer of the fabric for printing.

2. The printing method according to claim 1, wherein the water absorbency of the second layer is higher than water absorbency of the third layer.

3. The printing method according to claim 2, wherein the water absorbency of the first layer is higher than the water absorbency of the third layer.

4. The printing method according to claim 1, wherein the fabric contains natural fibers.

5. The printing method according to claim 1, wherein the content of the fibers in the second layer is from 65 mass % to 85 mass % with respect to the second layer.

6. The printing method according to claim 1, wherein the heating temperature is 140° C. or less in the forming step.

7. The printing method according to claim 1, wherein a pressing pressure is 0.70 MPa or less in the forming step.

8. The printing method according to claim 1, wherein the second layer comprises a lower layer and an upper layer;
in the depositing step, a first web serving as the lower layer is produced on the fabric serving as the first layer, a second web serving as the upper layer is produced on the first web; and
the water absorbency of the lower layer is higher than the water absorbency of the upper layer.

9. The printing method according to claim 8, wherein the basis weight of the first web is larger than the basis weight of the second web.

10. A fabric for printing comprising:
a first layer having air permeability;
a second layer laminated on the first layer and formed by depositing fibers and having water absorbency; and
a third layer laminated on the second layer and subjected to inkjet printing,
wherein the thickness of the third layer is less than the thickness of the second layer, and the water absorbency of the second layer is higher than the water absorbency of the third layer.
